(19) United States
(12) Patent Application Publication
(10) Pub. No.: US 2014/0082667 A1
(43) Pub. Date: Mar. 20, 2014

(54) TELEVISION PROGRAM PLAYING CONTROL METHOD AND THE SYSTEM THEREOF

(71) Applicant: Quatius Limited, Hong Kong (CN)

(72) Inventor: Ka Wing CHEUNG, Hong Kong (CN)

(21) Appl. No.: 14/025,043

(22) Filed: Sep. 12, 2013

(30) Foreign Application Priority Data
Sep. 14, 2012 (CN) CN 201210344686.7

(51) Int. Cl. H04N 21/488

(52) U.S. Cl. CPC H04N 21/4882
USPC 725/38

(57) ABSTRACT

A television program playing control method and the system thereof are disclosed. The method includes the following steps: creating a television control interface which comprises a television program playing window and a message push window. The television program playing window is configured to play television program, and the message push window is configured to display push message acquired from a background server; while receiving a triggering command for the push message, acquire network link corresponding to the push message, and connect to internet according to the network link, and visit network object corresponding to the push message. It can expediently visit network while displaying television image, and through network push related network message to television users.

### CROSS-REFERENCE TO RELATED APPLICATIONS

This application claims priority under 35 U.S.C. §119 to Chinese application filed on Sep. 14, 2012, and having serial number CN 201210344686.7, wherein the entirety of said application is incorporated herein by reference.

### FILED OF THE INVENTION

The present invention relates to the field of television control, and more particularly to a television program playing control method and the system thereof.

### BACKGROUND OF THE INVENTION

Nowadays, the digital television has been widely used. One important difference between the digital television and the traditional television is that in addition to play the television program, the digital television can also access the network. The digital television can thus have network functions that can not be realized by traditional television.

The known digital television has the same playing mode of television program as that of the traditional television, that is, under the television mode, the television image is displayed within the entire area of the screen. But when a user would like to use the internet function, it is necessary to switch television mode into internet mode by using a remote controller, cut off the television signal and then run a browser to access the network. This is quite inconvenient. Under the television mode, the user can only watch the television image, and difficult to acquire other useful relative information, such as the up-to-date program information, ways for obtaining relative television program, etc.

### SUMMARY OF THE INVENTION

Aiming at those existed problems as above, the present invention is objected to provide a television program playing control method and a system for controlling television program playing, by which it is convenient to access the network and capable to push relative network message to a user through network.

A television program playing control method includes the following steps:

creating a television control interface with a television program playing window and a message push window, wherein the television program playing window is configured to play television program, and the message push window is configured to display push message acquired from a backend server; and

acquiring a network link corresponding to the push message when receiving a triggering command for the push message, accessing a network object corresponding to the push message via the network link.

A system for controlling television program playing includes:

A playing interface module, configured to create a television control interface comprising a television program playing window configured to play television program and a message push window configured to display push message acquired from a backend server;

A control module, configured to acquire a network link corresponding to the push message when receiving a triggering command for the push message, and to access a network object corresponding to the push message through the network link.

The method and system for controlling television program playing described in this invention is to play TV program in the play window by creating a television control interface which contains a television program playing window and a message push window, and the message push window displaying push message at the backend server, therefore the TV images are able to be displayed and at the same time you can easily access the selected network. It is convenient to access the network and push relative network message to television users through the message push window. Users can also directly trigger the push message displayed in the message push window, and quickly connect to the internet to access the corresponding network object, which is very convenient for the users.

### BRIEF DESCRIPTION OF THE DRAWINGS

FIG. 1 shows a process flowchart of a method for controlling the playing of television program according to one embodiment of the present invention.

FIG. 2 shows a schematic diagram of a television control interface created in the method according to one embodiment of the present invention.

FIG. 3 shows a structural schematic diagram of a system for controlling television program playing according to one embodiment of the present invention.

### DETAILED DESCRIPTION OF THE PREFERRED EMBODIMENTS

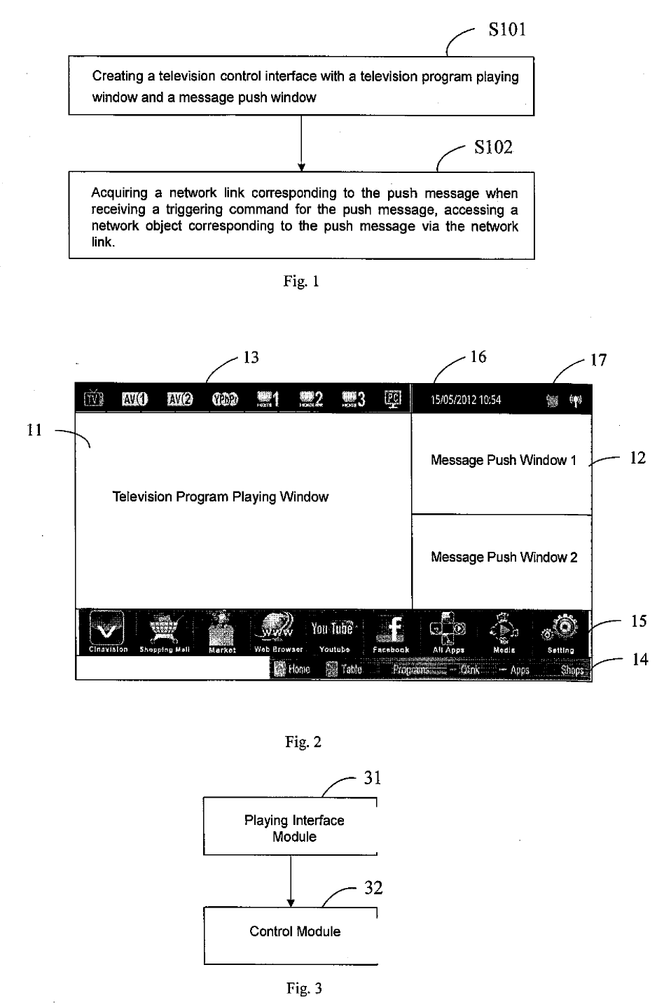

Referring to FIG. 1, a process flowchart of a method for controlling the playing of television program according to an embodiment of the present invention is shown.

The television program playing control method includes the following steps. S101, creating a television control interface with a television program playing window and a message push window. The television program playing window is configured to play television program, and the message push window is configured to display push message acquired from a backend server.

The television control interface is a user interface displayed on the television screen, and used to display the television images and other messages, and realize the control interaction between the user and the television. Two major parts of the television control interface are a television program playing window and a message push window. The television program playing window is configured to play television program, and the television program includes videos from different signal sources of television, such as TV, AV1 and AV2. The background server is an information server on the network, which can push network message to each individual television client. The information server can be a server of the television program operator or a server especially built for providing push message service for the television control interface. The message push window is configured to display push message acquired from a background server, and can display push message acquired from one or more background servers. Preferably, the message push window is divided into several zones, and displays different push messages in different zones. For example, a first zone displays the newest list of advance notices of programs acquired from the server of the television program operator, and a second zone displays the newest message about movies and television shows; or the first zone displays business advertisement message and the second zone displays application store message, which reflects the advertisement message to television terminals through WEB VIEW. S102, when receiving a triggering command for the push message, acquire a network link corresponding to the push message, and access a network object corresponding to the push message through the network link.

After browsing the push message displayed by the message push window, if the user would like to know more information, the system can acquire the network link corresponding to the push message automatically after receiving the triggering command for the push message, and access a network object corresponding to the push message through the network link.

The triggering command may be set in different ways. For example, when a corresponding button of the remote controller is pressed by the user, then a triggering command corresponding to the push message is sent to open the browser to enter the application store or the corresponding webpage according to the network link corresponding to the push message or enter the application store. Or move a mouse of the remote controller to the scope of the message push window and click a “confirmation button”, and this may also send out the triggering command corresponding to the push message.

In the television program playing control method according to this embodiment, by creating a television control interface that includes a television program playing window and a message push window, the television program is played in the television program playing window, and push messages acquired from a background server are displayed in the message push window. Therefore, it is convenient to access the network and push relative network messages to television users through the message push window, while the television program is being displayed. The user can trigger the push message displayed in the message push window directly, and access a corresponding network object through network, which is convenient to the user.

Referring to FIG. 2, a schematic diagram of the television control interface according to one embodiment of the present invention is shown.

In this embodiment, the television control interface includes a television program playing window 11 and a message push window 12, and the television program playing window 11 is located at the left center of the whole television control interface, and the message push window 12 is divided into two zones (two zones at the right center), one of which is a upper zone for push messages of advertisement, and the other one of which is a lower zone for push messages for application store.

In this embodiment, the television control interface may further include a signal source selection control 13. If the signal source selection control 13 receives a signal source selection command, then acquire television program from corresponding signal sources according to the signal source selection command, and play it in the television program playing window.

The signal source selection control 13 is also known as a SOURCE channel selection control, and the user can use the following ways to switch the SOURCE channel:

1. Press SOURCE button on the remote controller to shift channels;

2. Press mouse button on the remote controller to change an arrow into a mouse function button, and move the arrow to the corresponding SOURCE channel (i.e. signal source) on the television control interface, and press the OK button to switch channels;

3. Press the left button of HID (Human Interface Device) mouse pointing at the SOURCE channel position to switch channels.

In the signal source selection control 13, colors can be applied to label the corresponding signal source from which the video is being played, for example, icon in green is the current channel, and icon in white is the inactivated channel.

By setting the signal source selection control 13, the user can choose different types of television signal sources, such as TV, AV1, AV2, HMI, PC, etc., and switch among different types of signal sources, which is very convenient.

In this embodiment, the television control interface may, further include a user operation command control 14. If the user operation command control 14 receives a control command, then execute a corresponding control operation according to the control command.

The user operation command control 14 indicates the ways to quickly operate by remote controller, which includes the following buttons: Home, Table/Point, Programs, Qlink, Apps and Shops. “Home” is a shortcut key. When the shortcut key “Home” is triggered, all statuses return to the main page. If the shortcut key on the main page is pressed, then return to a full screen page of the previous channel. The shortcut key enables the user to switch the TV between full screen model and main page of the television control interface according to his needs, which is very convenient.

“Table/Point” is a direction switch button. With this switch button, the mouse function or desktop function can be switched.

“Programs” is a shortcut key for selecting program. Press the red button “Programs” on the remote controller on the main page of the television control interface, or trigger the “Programs” button on the main page of the television control interface by a mouse, to select programs. All application programs are defaulted as the first icons.

“Qlink” is a shortcut key for quickly starting the currently running application programs under ANDROID state. The system records an execution action of an application program of the user automatically, and triggers the “Qlink” key to display the application programs executed by the user recently, and the user does not need to spend time in checking one by one in a summary list of application programs.

“Apps” is a shortcut key for starting the browser to enter an application program store.

“Shops” is a shortcut key for starting the browser and starting a corresponding webpage according to advertisement link designed by a background service provider.

The television control interface further includes an application selection control 15. If the application selection control 15 receives an application program selection command, then execute a corresponding application program according to the application program selection command.

In this embodiment, Preinstall relative application program APK (Android Package, i.e. Android installation package) in advance ,which can not be deleted by the user. All application programs, browsers, settings, installation and management function, media function, management function and YOUTUBE function are preferably in locked status.

The television control interface may further include a date and time control 16 and/or a network status displaying control 17. The date and time control 16 is configured to display date and time. The network status displaying control 17 is configured to display internet connection status.

The date and time displayed by the date and time control 16 may be obtained by three kinds of ways: obtaining date and time message carried by DTV (i.e. digital image bit stream); obtaining date and time message by network; or setting date and time message manually. The prior order setting of the above three types of date and time is DTV>network setting>manual setting. That means, firstly, connecting to TDT (TDT is a time and date table of MPEG-2 transport stream) of the reflection SI message and a TOT chart of the DTV signal (TOT is Time Offset Table). If the DTV signal is lost, the network terminal will automatically obtains background time of ANDROID standard connection, or the manual setting can also be used. The three types of time mentioned above can be checked under the SETTINGS.

Network connection status displayed by the network status displaying control 17 includes: cable network, wireless network and no network connection. Cable network and wireless network are shown by different icons, and when one of the two icons is orange, the current status is this kind of network connection. If both of the two icons are white, then it represents the status of no network connection.

In a preferred embodiment, the wireless network is locked, and a single mode USB wireless network software protector is set to improve safety of network connection.

Referring to FIG. 3, a structural schematic diagram of a system for controlling television program playing according to one embodiment of the present invention is shown.

The system for controlling television program playing includes a playing interface module 31 and a control module 32.

The playing interface module 31 is configured to create a television control interface that includes a television program playing window and a message push window, the television program playing window is configured to play television program, and the message push window is configured to display push message acquired from a background server.

The control module 32 is configured to acquire network link corresponding to the push message when receiving a triggering command for the push message, connect to network according to the network link and access a network object corresponding to the push message.

In the television program playing control method, by creating a television control interface with a television program playing window and a message push window, television programs can be played in the television program playing window, and push messages acquired from a background server are displayed in the message push window. Therefore, it is convenient to access the network and push relative network messages to television users by the message push window, while the television images are being displayed. The user can trigger the push messages displayed in the message push window, and connect to network quickly and access a corresponding network object, which is convenient to the user.

The television control interface is a user interface displayed on a television screen. With the television control interface, the television program and other messages are displayed, and the control command interaction between user and television is realized. Two major parts of the television image control are the television program playing window and the message push window. The television program playing window is configured to play television program, and the television images may be from different source of television, like TV, AV1 and AV2.

The background server is an information server provided on the network, which can push network messages to each individual television client through network. The information server can be a server of a television program operator or a server especially built for providing push message service for the television control interface. The message push window is configured to display push messages acquired from a background server, which can display push messages acquired from one or more background servers. Preferably, the message push window created by the playing interface module 13 is divided into several zones, and different push messages can be displayed in different areas, for example, a first zone displays the newest list of advance notices of programs acquired from the server of the television program operator, and a second zone displays the newest message about movies and television shows. As a choice, the first zone may display business advertisement messages and the second zone may display application store messages, which reflects the advertisement message to television terminals through web view.

After browsing the push message displayed by the message push window, if the user would like to know more relative messages, after receiving a triggering command for the push message, the control module 32 will acquire a network link corresponding to the push message automatically, and access a network object corresponding to the push message through the network link.

Triggering mode of the triggering command may have many types of settings, for example, the user may press a corresponding button of the remote controller to directly send out a triggering command corresponding to the push message to open the browser and then open the corresponding webpage according to the network link corresponding to the push message or enter the application store; or move a mouse of the remote controller to the scope of the message push window and click a “confirmation button”, and this may also send out the triggering command corresponding to the push message.

In one embodiment, the television program playing window of the television control interface created by the playing interface module 31 is located at the left center of the whole of the television control interface, and the message push window 12 is divided into two zones (two zones in the right center), one of which is a upper zone for push messages for advertisement, and the other of which is a lower zone for push messages for application store.

The television control interface created by the playing interface module 31 may further include a signal source selection control. When the signal source selection control receives a signal source selection command, the control module 32 acquires the television program from a corresponding signal source according to the signal source selection command, and displays it in the television program playing window.

The signal source selection control 13 is also known as a SOURCE channel selection control, and the user can use the following ways to switch SOURCE channels:

1. Press a SOURCE button on a remote controller to switch SOURCE channels;

2. Press a mouse button on a remote controller to change an arrow into mouse function buttons, and move the arrow to the corresponding SOURCE channel (i.e. signal source) on the television control interface, and click OK button to switch SOURCE channels;

3. Press the left button of HID (Human Interface Device) keyboard mouse pointing at the SOURCE channel position to switch channels.

In the signal source selection control, colors can be applied to label the corresponding signal source from which the image is being displayed. For example, icon in green may be used to indicate the current channel, and icon in white may be used to indicate an inactivated channel.

By setting the signal source selection control, the user can conveniently choose different types of signal sources such as TV, AV1, AV2, HDMI, PC, etc., and switch among different types of signal sources, which is very convenient.

The television control interface created by the playing interface module 31 may further include a user operation command control. When the user operation command control receives a control command, the control module 32 executes a corresponding control operation according to the control command.

The user operation command control indicates the ways to quickly operate by a remote controller, and it includes the following buttons: Home, Table/Point, Programs, Qlink, Apps and Shops.

“Home” is a shortcut key. When the shortcut key Home is triggered, all statuses return to the main page. If press the shortcut key on the main page, then return to a full screen page of the previously opened channel. The shortcut key enables the user to switch the TV full screen mode and the main page of the television control interface according his need, which is very convenient.

“Table/Point” is a direction switch button: by the switch button, mouse function or desktop function can be switched.

“Programs” is a shortcut key for selecting program. Press a red button Programs on the remote controller on the main page of the television control interface, or trigger the “Programs” button on the main page of the television control interface by a mouse, which make selecting program areas more conveniently. All application programs are defaulted as the first icons.

“Qlink” is a shortcut key for quickly starting currently running application programs under ANDROID status. The system automatically records the execution action of application program of the user, and triggers the “Qlink” key to display the application programs executed by the user recently, and the user does not need to spend time in checking one by one in a summary list of application programs.

“Apps” is a shortcut key for starting the browser to enter application program store.

“Shops” is a shortcut key for starting the browser and starting corresponding webpage according to advertisement linkage designed by a background service provider.

The television control interface created by the playing interface module 31 further includes an application selection control; while the application selection control receives an application program selection command, the control module executes a corresponding application program according to the application program selection command.

In one embodiment, on a television terminal, a relative application program APK (AndroidPackage, i.e. Android installation package) is preset, which can not be deleted by the user. All application programs, browsers, settings, installation and management function, media function, management function and YOUTUBE function are preferably in locked status.

The television control interface created by the playing interface module 31 further comprises a date and time control and/or a network status displaying control; the date and time control is configured to display date and time; the network status displaying control is configured to display internet connection status.

The date and time displayed by the date and time control can be obtained by three ways, which are: obtaining date and time information carried by DTV (i.e. Digital image bit stream); obtaining date and time information by network; and setting date and time information manually. The prior order setting of the three types of date and time above is DTV>network setting>manual setting. That means, firstly, connecting to TDT (TDT is a time and date table of MPEG-2 transport stream) of the reflection SI information and TOT charts of DTV signals (TOT is Time Offset Table). If the DTV signal is lost, the network terminal will automatically obtain background time of ANDROID standard connection, or the manual setting can be used. The setting modes of the three types of time mentioned above can be checked under the SETTINGS.

The network connection status displayed by the network status displaying control includes: cable network, wireless network and no network connection. Cable network, wireless network are shown with different icons. When one of the two icons is orange, it represents the current network connection status. If both of the two icons are white, there is no network connection.

In a preferred embodiment, the wireless network is locked, and set a single mode USB wireless network software protector to improve safety of network connection.

A person skilled in the art can understand all or part of the procedures and the corresponding systems in the above embodiments may be accomplished by corresponding hardware commanded by a computer program. The program can be stored in a storage media readable by a computer. While the program is being executed, all above mentioned flow paths in the embodiments can be included. Wherein, the storage media can be diskette, CD, ROM (Read-Only Memory) or RAM (Random Access Memory□RAM) etc.

The above embodiments only show several execution means of the present invention, which describes more specific and detailed, but it should not be understood that the embodiments will limit the scope of the present invention. It should be noted that, for the skilled person in the art, several modifications and improvements could be made without departing from the spirit of the present invention, which are under the scope of the present invention. Therefore, the scope of the present invention is according to the appended claims.

What is claimed is:

1. A television program playing control method, comprising:
creating a television control interface with a television program playing window and a message push window, wherein the television program playing window is configured to play television program, and the message push window is configured to display push message acquired from a background server; and
acquiring a network link corresponding to the push message when receiving a triggering command for the push message, accessing a network object corresponding to the push message through the network link.

2. The method of claim 1, wherein the television control interface further comprises a signal source selection control, wherein if a signal source selection command is received by the signal source selection control, then acquire a television program from a corresponding signal source according to the signal source selection command, and play the television program in the television program playing window.

3. The method of claim 1, wherein the television control interface further comprises a user operation command control, wherein if a control command is received by the user operation command control, then a corresponding control operation is executed according to the control command.

4. The method of claim 1, wherein the television control interface further comprises an application selection control, wherein if an application program selection command is received by the application selection control, then execute a corresponding application program according to the application program selection command.

5. The method of claim 1, wherein the television control interface further comprises:
a date and time control, configured to display date and time; and/or
a network status displaying control, configured to display network connection status.

6. A system for controlling television program playing, comprising:
a playing interface module, configured to create a television control interface comprising a television program playing window configure to play television program and a message push window configured to display push message acquired from a background server;
a control module, configured to acquire a network link corresponding to the push message when receiving a triggering command for the push message, and to access a network object corresponding to the push message through the network link.

7. The system of claim 6, wherein the television control interface further comprises a signal source selection control, and the control module is configured to acquire, when a signal source selection command is received by the signal source selection control, a television program from a corresponding signal source according to the signal source selection command, and play the television program in the television program playing window.

8. The system of claim 6, wherein the television control interface further comprises a user operation command control, and the control module is configured to execute a corresponding control operation when a control command is received by the user operation command control.

9. The system of claim 6, wherein the television control interface further comprises an application selection control;
when an application program selection command is received by the application selection control, a corresponding application program is executed by the control module according to the application program selection command.

10. The system of claim 6, wherein the television control interface further comprises:
a date and time control, configured to display date and time; and/or
a network status displaying control, configured to display network connection status.
